(19) United States
(12) Patent Application Publication
(10) Pub. No.: US 2004/0179579 A1
(43) Pub. Date: Sep. 16, 2004

(54) Method and apparatus for determination of initialization states in pseudo-noise sequences

(76) Inventor: Robert Denk, Grafing (DE)

Correspondence Address: Andreas Grubert, Baker Botts L.L.P., One Shell Plaza, 910 Louisiana, Houston, TX, 77002-4995, US

(21) Appl. No.: 10/810,531

(22) Filed: Mar. 26, 2004

Related U.S. Application Data
(63) Continuation of application No. PCT/DE02/02708, filed on Jul. 23, 2002.

(30) Foreign Application Priority Data
Sep. 26, 2001 (DE) 101 47 306.0

(51) Int. Cl. H04B 1/69

(52) U.S. Cl. 375/130

(57) ABSTRACT

The method makes it possible to determine, by calculation, a state, which has n bits and is iterated N times, of a shift register arrangement from a given initial state. This allows pseudo-noise sequences with any desired offset N to be produced, without prior iterations having to be carried out for this purpose. A matrix whose j-th row, where j=1, . . . , n, is given by the coefficients of that representative of the remaining class [x^{N+j-1}]mod f* whose degree is less than n is used for calculation of the n state, which is iterated N times.

### CROSS REFERENCE TO RELATED APPLICATION

This application is a continuation of copending International Application No. PCT/DE02/02708 filed Jul. 23, 2002 which designates the United States, and claims priority to German application no. 101 47 306.0 filed Sep. 26, 2001.

### TECHNICAL FIELD OF THE INVENTION

The present invention relates to a method and an apparatus for determination of an end state, which has n bits and is iterated N times, of a shift register arrangement from a given initial state, which has n bits, of the shift register arrangement. The invention also relates to the production of pseudo-noises sequences which are shifted through N bits and are used in particular as spreading sequences in CDMA-based mobile radio systems (CDMA: Code Division Multiple Access).

### BACKGROUND OF THE INVENTION

In a mobile radio system, the signals which are generated by the base station or by the mobile station are modified a number of times before being transmitted. In order, inter alia, to make it possible to distinguish between different cells in a mobile radio network, CDMA systems use spreading sequences, with each user in each logical channel being allocated a different sequence of the values −1 and 1. The signal which is allocated to the individual user can thus be received, and can be separated from the other signals and can be reconstructed. This is referred to as code division multiple access (CDMA). In contrast to this, the signals in TDMA systems (Time Division Multiple Access) are separated from one another in time. Important CDMA transmission systems are the IS-95 system that is used in the USA and the UMTS system, which has been specified in 3rd Generation Partnership Project (3GPP). The detailed description of the coding that is used for UMTS can be found in “3GPP: Spreading and modulation (FDD)” 3rd Generation Partnership Project TS 25.213, Release 1999.

All the spreading codes which are used can be traced back to sequences of binary values 0 and 1. These sequences may, for example, be so-called pseudo-noise sequences, which are identified by defined autocorrelation and cross-correlation characteristics. While a pseudo-noise sequence is represented in the theoretical representation as a sequence of binary values 0 and 1, the spreading sequence which is actually used is a sequence of the values +1 and −1. The binary value 0 in each case becomes the value +1 in the actual spreading sequence.

Pseudo-noise sequences are defined by an iteration rule, with the iteration being carried out in the body GF(2), that is to say in the counting body with two elements 0 and 1. The theoretical basis of pseudo-noise sequences and the defining iteration rule is the theory of irreducible primitive polynomials over the body GF(2). A description of this theory and its application in the mobile radio field can be found, for example, in “CDMA Systems Engineering Handbook” by J. S. Lee, L. E. Miller, Artech House, Boston/London, 1998, particularly in Chapter 6, there.

Every individual pseudo-noise sequence is uniquely defined by the initial state, that is to say by the first values of the sequence, and by the polynomial which is used for the iteration process. In this case, the polynomial and hence the iteration rule in mobile radio applications are defined either for the entire network, or else only a small number of different polynomials are used overall, as is the case, for example, for the definition of the so-called scrambling codes in UMTS systems. The initial state is different for each individual pseudo-noise sequence, and is frequently defined by the code number.

The associated pseudo-noise sequence must therefore be generated in a base station or in a mobile station for a given code number and for a likewise predetermined iteration rule. When transmitting, the sequence which is produced must be used for coding the signal. In the reception mode, on the other hand, the use of the pseudo-noise sequence makes it possible to identify the desired signal and to distinguish it from the signals from other users. If the initial values of the sought sequence are known, the further sequence values can be produced by simple register operations without any difficulties. In the process, attention must be paid to the synchronization between the information to be transmitted and that received, on the one hand, and the constructed sequence, on the other hand.

However, in various mobile radio applications, the start of the sequence and hence the initial state of the registers are not known. This is the situation, for example, when the coding is intended to be started at a different time from the signal transmission itself. This situation occurs in the so-called compressed mode in UMTS. Further information relating to this mode can be found in “3GPP: Physical channels and mapping of transport channels onto physical channels (FDD)”, 3rd Generation Partnership Project TS 25.211, Release 1999.

The start of the sequence and hence the initial state of the registers is also unknown when the code number does not directly define the initial register contents but, instead of this, defines a shift by a specific number of bits in the pseudo-noise sequence that is used. For example, when a signal is received in the mobile part in UMTS, the code number N is defined, in accordance with the 3GPP standard, as a pseudo-noise sequence shifted by N bits. Further information relating to this relationship between the code number and the associated pseudo-noise sequence is contained, in particular in Section 5.2, of “3GPP: Spreading and modulation (FDD)”, 3rd Generation Partnership Project TS 25.213, Release 1999.

In order to calculate the initial state of the registers for the situation where the sequence has been subjected to an additional shift or an additional offset of N bits, the sequence can be started at the original start time, and can then be iterated N times. The desired sequence shifted by N bits can be obtained in this way.

This solution was adopted in previous systems according to the prior art. Before outputting the desired pseudo-noise sequence, the register content of the shift register structure was iterated N times. The process of outputting the actual pseudo-noise sequence, shifted by N bits, was not started until these prior iterations had been carried out. One disadvantage of this procedure is that the number of operations required is proportional to the magnitude of the desired shift N. The number of operations required thus varies as a function of the data at that time, and this makes it more difficult to control the overall time sequence. A further disadvantage is that the computational complexity and amount of time required become very large when the desired shift N is large. During reception in UMTS systems, the offsets in the range N=0 to N=262142 occur in the mobile station. Since the production of the desired pseudo-noise sequence has to wait until the desired offset is reached, this means an unacceptable delay in transmission and reception.

### SUMMARY OF THE INVENTION

The object of the invention is thus to calculate the end state, iterated N times, and/or the pseudo-noise sequence shifted by N bits, for a given initial state in a direct manner.

In the method according to the invention for determination of an end state, which has n bits and is iterated N times, of a shift register arrangement from a given initial state, which has n bits, of the shift register arrangement, the iteration rule is given by the characteristic polynomial

f(x)=1+c₁·x+c₂·x²+ . . . +cₙ₋₁·xⁿ⁻¹+xⁿ

where c₁, c₂, . . . cₙ₋₁ε{0;1}. In a first step, the polynomial

f*(x)=1+cₙ₋₁·x+cₙ₋₂·x² + . . . +xⁿ

is determined by reflecting the coefficients of the polynomial

f(x)=1+c₁·x+c₂·x²+ . . . +cₙ₋₁·xⁿ⁻¹+xⁿ

Those representatives of the remaining class

[x^{N+j-1}]modf*

whose degree is less than n are then determined for j=1, . . . , n. The bit sequence of the initial state is then multiplied by a matrix whose j-th row or j-th column is given, for j=1, . . . , n, by the coefficients of the representative of the remaining class

[x^{N+j-1}]modf*

The method according to the invention for the first time makes it possible to explicitly calculate the state of a shift register arrangement which is defined by a characteristic polynomial and is obtained after carrying out N iterations. In the prior art, N iterations of the shift register arrangement had to be carried out in advance in order to determine this end state. Since, in some cases, up to N=262142 prior iterations had to be carried out in order to produce the various codes required for mobile radio transmission, the capability to calculate the end state, iterated N times, explicitly results in an immense time saving. The invention offers the capability to produce a specific code sequence, shifted through the offset N, virtually without any delay.

The process of determining that representative in the remaining class

[x^{N+j-1}]modf*

whose degree is less than n can be carried out by means of fast algorithms for remaining class calculation, for example by means of square and multiply algorithms, in a very short time. In this case, the computational complexity and the time required to determine a representative in the remaining class

[x^{N+j-1}]modf*

is related logarithmically to N, that is to say there is a logarithmic relationship with the desired offset shift of the code sequence. When carrying out N prior iterations, as was necessary in the prior art, the computational complexity and time required to carry out the prior iterations increased linearly with N. Owing to the logarithmic relationship with N, the solution according to the invention results in the computation required being shortened enormously, particularly for large values of N.

Pseudo-noise sequences produced by shift register arrangements are required in particular for transmitter-end coding and for receiver-end decoding of data packets for mobile radio transmission. With previous solutions, the need to carry out N prior iterations resulted in an unacceptable delay in the transmission and reception processes. Delays such as these can be avoided with the solution according to the invention since, in this case, the end state, which is iterated N times, is determined by means of a matrix multiplication, and not iteratively as in the past.

Code sequences which are shifted through N bits are denoted by the code number N in accordance with the 3GPP standard. The invention thus makes it possible to produce all of the codes defined in the 3GPP standard mobile radio transmission without any waiting time. When coded signals are being transmitted by radio, a situation also occurs in which the coding is intended to be started at a different time than the signal transmission itself. This is the case, for example, with the so-called compressed mode in the UMTS mobile radio standard. The correct initial state of the shift register arrangement for signal coding in the compressed mode can thus be generated by means of the method according to the invention, which can instantaneously produce a shift register arrangement state which has been iterated N times.

The invention is suitable for all applications in which code sequences are produced by means of a clock shift register arrangement with feedback. In this case, the feedback which is provided in the shift register arrangement is defined by the characteristic polynomial

f(x)=1+c₁·x+c₂·x²+ . . . +cₙ₋₁·xⁿ⁻¹+xⁿ

The shift register content, which has n bits, is shifted through the shift register arrangement by a clock signal, with bits which are shifted out of the shift register being fed back to the input of the shift register arrangement. Shift register arrangements such as these are used for coding and decoding purposes. The method according to the invention makes it possible to calculate, for a given initial state of the shift register arrangement, that end state which is reached after N shift operations, or after N clock pulses have been applied to the shift register.

The calculation of the end state according to the invention requires the calculation of a matrix and the multiplication of the initial state by this matrix. The calculation of the matrix elements and the process of carrying out the matrix multiplication may in this case be carried out by a processor, in particular by a digital signal processor. The calculated end state can then be used for initialization of the shift register arrangement, which is in the form of hardware. The invention makes it possible to reliably determine the various initialization states required for code generation, with little computational effort.

In this case, it is advantageous for the representatives of the remaining classes

[x^{N}]modf*, [x^{N+1}]modf*, . . . [x^{N+n-1}]modf*

each to be calculated explicitly by means of a suitable algorithm, in particular by means of a square and multiply algorithm. For calculation of the remaining classes

[x^{m}]modf*,

of Monomen, where m is a natural number, there is a range of different algorithms, each of which produce the coefficients of that representative of the remaining class whose degree is less than n. The computational complexity and time required for carrying out these algorithms in this case depends logarithmically on m. The matrix elements which are required to carry out the method according to the invention can thus be produced quickly even for large values of N.

In this case, it is particularly advantageous for the square and multiply algorithm to be used. On the basis of the representative in the remaining class

[x]modf*,

the representative of

[x^{m}]mod f*

can be calculated very quickly by using a square and multiply method, where m is a natural number. A square and multiply algorithm such as this is explained explicitly in the description in this patent application. The algorithm comprises only a few lines, can be implemented easily and produces reliable results for the coefficients of the representative in the remaining class

[x^{m}]modf*.

According to one advantageous embodiment of the invention, only the representative in the remaining class

[x^{N}]modf*

is calculated explicitly by means of a suitable algorithm, in particular by means of a square and multiply algorithm. The representatives of the remaining classes

[x^{N+j-1}]modf*

where j=2, . . . , n are, in contrast, obtained by (n−1) calculated iterations from the coefficients of the representative of the remaining class

[x^{N}]modf*

Instead of having to determine the representatives

[x^{N+j-1}]modf*

for all N rows in the matrix to be determined by using a square and multiply algorithm, the square and multiply algorithm is in this embodiment of the invention now carried out only for the first row in the matrix. The matrix elements in the remaining (n−1) rows of the matrix are then produced by means of (n−1) calculated iterations of these coefficients. The matrix elements in the (j+1)-th row can always be determined from the matrix elements in the j-th row. The advantage of this procedure over calling the algorithm n-times is further computational simplification of the process of determining the matrix elements. The number of computation steps required to determine the matrix elements is reduced further, so that the end state, which has been iterated N times, can be calculated in an even shorter time.

In this case, it is advantageous for the representatives of the remaining classes

[x^{N+j-1}]modf*

where j=2, . . . , n to be obtained by (n−1) calculated iterations of a shift register arrangement of the MSRG type (Modular Shift Register Generator) from the coefficients of the representative of the remaining class:

[x^{N}]modf*

with the iteration rule for the shift register arrangement being given by the characteristic polynomial

f*(x)=1+cₙ₋₁·x+cₙ₋₂·x²+ . . . +xⁿ

In order to obtain the coefficients of the representative of the remaining class

└X^{N+j-1}┘modf*

from the coefficients of the representative of the remaining class

¥X^{N+j-1}┘modf*

that is to say to derive the (j+1)-th row from the j-th row, a calculated iteration of these coefficients is carried out, corresponding to shifting these coefficients through a shift register of the MSRG type. The structure of a shift register of the MSRG type is defined by the characteristic polynomial

f*(x)=1+cₙ₋₁·x+cₙ₋₂·x²+ . . . xⁿ

However, the iterative determination of the matrix elements is generally not carried out by a shift register arrangement in the form of hardware, but purely computationally by means of software or by means of a processor, for example a digital signal processor.

The explicit calculation of the first matrix row, that is to say of the coefficients of the representative of the remaining class

└x^{N}┘modf*,

and the iterative derivation of the remaining coefficients represents the quickest and simplest possible way to calculate all the matrix elements.

It is advantageous for the end state, which has n bits and is iterated N times, to be used as the initialization state for production of a pseudo-noise sequence which is shifted by N bits. A sequence of binary values which is produced by a shift register arrangement that has feedback and is described by an irreducible polynomial is referred to as a pseudo-noise sequence. A pseudo-noise sequence is defined firstly by the initial state of the shift register arrangement and secondly by the characteristic polynomial of the shift register arrangement. If the end state, which has been calculated by means of the method according to the invention and has been iterated N times, is used as the initialization state for the production of a pseudo-noise sequence, then this means that the pseudo-noise sequence can be started immediately at the desired point, shifted through N bits. The further sequence values are then produced on the basis of the initialization state.

It is advantageous for the end state, which has n bits and is iterated N times, to be written as the initialization state to a shift register arrangement which has n shift register cells. The end state which has been iterated N times is calculated by means of the method according to the invention and is then written to the shift register arrangement, which is in the form of hardware. Since the calculated end state, which has been iterated N times, corresponds precisely to the state of the shift register arrangement after carrying out N iterations, it is possible to produce the desired pseudo-noise sequence, which has been shifted through N bits, on the basis of the calculated initialization state. Once the calculated initialization state has been written to the shift register arrangement, it is no longer possible to tell whether this state has been reached by means of N prior iterations of the shift register arrangement or by

It is advantageous for the shift register arrangement to be a shift register arrangement of the SSRG type which has n shift register cells and whose structure is given by the characteristic polynomial

f(x)=1+c₁·x+c₂·x²+ . . . +cₙ₋₁·xⁿ⁻¹+xⁿ

If the shift register arrangement is in the form of hardware, the SSRG type (Simple Shift Register Generator) has the advantage over the MSRG type (Modular Shift Register Generator) that the contents of a shift register cell in the SSRG type are shifted directly to the next shift register cell. In the MSRG type, on the other hand, XOR gates are connected between the individual shift register cells, and these modify the content of a register cell when it is moved to the next register cells. The register cell contents are not modified in shift registers of the SSRG type, and shift register arrangements such as these can therefore be implemented in a simple way as an array of register cells.

The pseudo-noise sequence which is produced by the shift register arrangement can be tapped off at the last register cell in the shift register arrangement. Each clock pulse that is used to move the contents of the shift register arrangement onwards results in a new binary value being written to the last register cell in the shift register arrangement. Thus, depending on the clock frequency that is used for clocking the shift register arrangement, the various sequence values in the pseudo-noise sequence are obtained successively by reading the last register cell in the shift register arrangement.

It is advantageous for the method to be used to produce a spreading sequence with an offset of N bits in CDMA transmission systems, in particular in CDMA transmission systems based on the UMTS or IS-95 transmission standard. Pseudo-noise sequences which can be produced by means of shift register arrangements with feedback are particularly suitable for mobile radio systems since their correlation characteristics are excellent for use as spreading sequences for CDMA-based systems. Spreading sequences are finite sequences of the values −1 and +1. When a data sequence is being transmitted, each value in the data sequence is multiplied by the spreading sequence. At the receiver end, those signals can then be distinguished and selectively decoded on the basis of the spread coding applied to them.

In order to make it possible to unambiguously decode the spread-coded signals at the receiver end, the spreading sequences which are used must have defined autocorrelation characteristics. Furthermore, it must be possible to distinguish well between signals which have been coded using different spreading sequences. To do this, the various spreading codes which are used for signal transmission must have defined cross-correlation characteristics. Pseudo-noise sequences are suitable for use as spreading sequences both with regard to the autocorrelation characteristics and with regard to the cross-correlation characteristics. Spreading sequences can therefore be produced by means of shift register arrangements with feedback in CDMA transmission systems.

The method according to the invention can be used to produce initialization states which make it possible to start with the n-th sequence value rather than with the first sequence value when outputting the spreading sequence. The invention therefore allows the production of spreading sequences which have been shifted by N bits, that is to say spreading sequences which have an offset of N bits.

According to one advantageous embodiment of the invention, the method is used for production of the various scrambling codes which are defined in the UMTS standard. Scrambling codes are spreading sequences which are used, inter alia, to distinguish between signals which are transmitted from different base stations to one mobile station. The solution according to the invention is suitable for production of scrambling codes which are shifted by N bits, that is to say of scrambling codes which have an offset of N bits. The solution according to the invention makes it possible to generate a large number of different scrambling codes on an ad-hoc basis.

According to one advantageous embodiment of the invention, the spread coding is started at a different time than the signal transmission in the CDMA transmission system, with the end state, which has n bits and is iterated N times, being used as the initialization state for the production of the time-shifted spreading sequence. This allows greater flexibility in the timing of transmission and reception processes. In particular, the compressed mode which is provided in the UMTS standard can be implemented with little complexity.

It is advantageous for the offset for a spreading sequence to be defined by a given code number, with the end state, which has n bits and is iterated N times, being used as the initialization state for the production of the spreading sequence which is associated with the code number N. This means that it is possible to address a large number of codes in a simple manner. The code number N which is used to identify a code is at the same time used as a critical parameter for code production, and may be used directly for code production. There is no need for any time-consuming conversion processes.

The method can be implement in an apparatus by respective means and the apparatus can be used for production of a spreading sequence.

### BRIEF DESCRIPTION OF THE DRAWING

The invention will be described in more detail in the following text with reference to a number of exemplary embodiments which are illustrated in the drawing, in which:

FIG. 1 shows the circuit diagram of a shift register of the SSRG type (Simple Shift Register Generator);

FIG. 2 shows the illustration, according to the invention, of the n×n matrix T^{N}, which, when multiplied by the initial state, directly produces the initialization state, which has been iterated N times, for the production of the shifted pseudo-noise sequence; and

FIG. 3 shows a table in which the number of required operations are compared with one another on the basis of the desired offset N for the previous method and for the method according to the invention.

### DESCRIPTION OF THE INVENTION

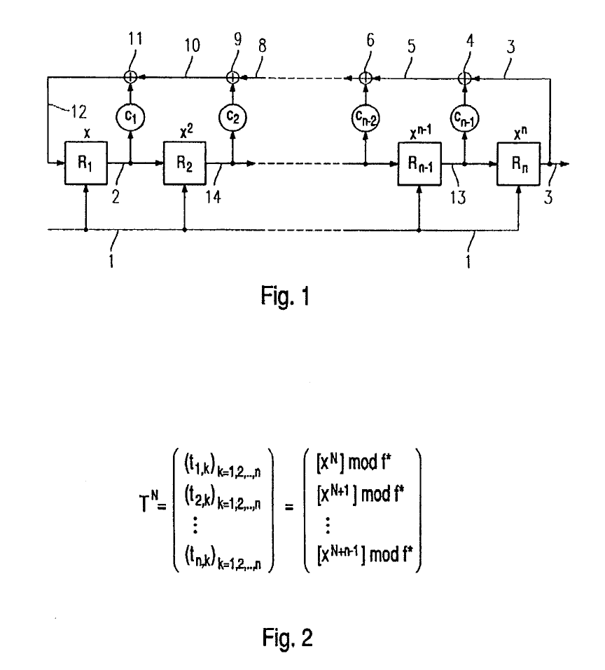

FIG. 1 shows the structure of a shift register of the SSRG type (Simple Shift Register Generator). The shift register has n register cells R₁, R₂, . . . , Rₙ₋₁, Rₙ, in which case the register content of one cell may in each case assume the values 0 or 1. Clock pulses are supplied to the register cells via a common clock line 1. The content of one register cell is transferred to the next register cell with each clock pulse. To do this, the output of one register cell is in each case connected to the input of the next register cell. For example, the output of the register cell R₁ is connected to the input of the register cell R₂ via the signal line 2. This means that the bit sequence which existed initially is shifted by one register cell or one bit position to the right with each clock pulse.

The signal 3 which can be tapped off at the output of the register cell Rₙ is modified by a number of XOR gates 4, 6, . . . , 9, 11 in order to produce the signal 12 which is applied to the input of the first register cell R₁. The way in which the signal 3 which can be tapped off at the output of Rₙ is modified in order to produce the signal 12 is governed by the coefficients c₁, c₂, . . . , cₙ₋₂, cₙ₋₁, which may each assume the value 0 or 1. When cᵢ (where i=1, 2, . . . , n−1) has the value 0, this means that the signal which can be tapped off at the output of the register cell Rᵢ has no influence whatsoever on the feedback signal. If, for example, cₙ₋₁=0, then the signal 3 is not modified by the signal 13 which can be tapped off at the output of the register cell Rₙ₋₁. The signal 3 which is applied to the first input of the XOR gate 4 is passed to the output of the XOR gate 4 without being changed, so that the signal 5 corresponds to the signal 3. If the coefficient cₙ₋₁=0, then the XOR gate 4 can therefore also be omitted and can be replaced by a direct link between the signal 3 and the signal 5.

If, on the other hand, one coefficient cᵢ (where i=1, 2, . . . , n−1) is equal to one, then the signal which can be tapped off at the output of the register cell Rᵢ contributes to the fed-back signal. If, for example, c₂=1, then the previous fed-back signal 8 is XOR-linked in the XOR gate 9 with the signal 14 which can be tapped off at the output of the register cell R₂, thus resulting in the modified fed-back signal 10. Since XOR linking may be described as a modulo-two addition, the XOR gates 4, 6, . . . , 9, 11 are shown as modulo-two adders in FIG. 1.

The recursion rule for a shift register of the type shown in FIG. 1 is governed by a characteristic polynomial in the form

f(x)=1+c₁·x+c₂·x²+ . . . +cₙ₋₁·xₙ₋₁+xⁿ

with the coefficients c₁, c₂, . . . , cₙ₋₁ corresponding to the coefficients shown in FIG. 1 and being able, in particular, to assume the values 0 or 1. Irreducible polynomials are used as the polynomials f(x) for the purpose of coding and decoding of signals. Irreducible polynomials are characterized in that they cannot be represented as a product of at least two factors which are themselves also polynomials with a degree greater than zero over the body GF(2). Irreducible polynomials can thus not be factorized into lower-degree polynomials.

Let us assume that the initial values of the register cells R₁, R₂, . . . , Rₙ are x₁(0), x₂(0), . . . , xₙ(0) at the time zero. The values of the registers x₁(t+1), x₂(t+1), . . . , xₙ(t+1) at the time t+1 can respectively be derived from the values of the registers x₁(t), x₂(t), . . . , xₙ(t) at the time t using the following recursion rule:

$$\begin{matrix}{x}_{n} ( t + 1 ) & = & {x}_{n - 1} ( t ) , \\ {x}_{n - 1} ( t + 1 ) & = & {x}_{n - 2} ( t ) , \\ ⋮ & & ⋮ \\ {x}_{2} ( t + 1 ) & = & {x}_{1} ( t ) , \\ {x}_{1} ( t + 1 ) & = & {c}_{1} \cdot {x}_{1} ( t ) + {c}_{2} \cdot {x}_{2} ( t ) + … + {c}_{n - 1} \cdot {x}_{n - 1} ( t ) + {x}_{n} ( t ) .\end{matrix}$$

The addition process which is used here is a modulo-two addition, that is to say an XOR operation. If f(x) is an irreducible polynomial, then a so-called pseudo-noise sequence

xₙ(0), xₙ(1), xₙ(2), xₙ(3), . . .

can be tapped off at the output of the shift register, as the signal 3. A new sequence value appears at the output of the shift register with each clock pulse of the clock signal 1.

The pseudo-noise sequences which can be produced with the hardware as shown in FIG. 1 have appropriate correlation characteristics for signal coding. Pseudo-noise sequences such as these are therefore used for production of spreading sequences at the transmitter end and the receiver end in CDMA methods such as UMTS or IS-95. The shift register structure which is illustrated in FIG. 1 thus represents the appropriate hardware for production of spreading sequences in mobile stations and base stations which use a CDMA method as the transmission standard.

The register vector

$$( \begin{matrix}{x}_{n} ( t ) \\ {x}_{n - 1} ( t ) \\ ⋮ \\ {x}_{2} ( t ) \\ {x}_{1} ( t )\end{matrix} )$$

represents the content of the register cells R1, R2, . . . Rn at the time t. If the n×n matrix T is defined as

$$T = ( \begin{matrix}0 & 1 & 0 & ⋯ & 0 & 0 \\ 0 & 0 & 1 & & & 0 \\ & & & & & \\ ⋮ & & & ⋰ & & ⋮ \\ & & & & 1 & 0 \\ 0 & & & & 0 & 1 \\ 1 & {c}_{n - 1} & {c}_{n - 2} & ⋯ & {c}_{2} & {c}_{1}\end{matrix} ) ,$$

then the recursion rule can be formulated as follows:

$$( \begin{matrix}{x}_{n} ( t + 1 ) \\ {x}_{n - 1} ( t + 1 ) \\ ⋮ \\ {x}_{2} ( t + 1 ) \\ {x}_{1} ( t + 1 )\end{matrix} ) = T \cdot ( \begin{matrix}{x}_{n} ( t ) \\ {x}_{n - 1} ( t ) \\ ⋮ \\ {x}_{2} ( t ) \\ {x}_{1} ( t )\end{matrix} ) .$$

The n×n matrix T is also referred to as the characteristic recursion matrix. A single iteration of the code sequence may thus be represented as the matrix T being multiplied by the register vector. In a corresponding manner, a shift in the code sequence through an offset N may be represented as the register vector being multiplied by the matrix T^{N}:

$$( \begin{matrix}{x}_{n} ( t + N ) \\ {x}_{n - 1} ( t + N ) \\ ⋮ \\ {x}_{2} ( t + N ) \\ {x}_{1} ( t + N )\end{matrix} ) = {T}^{N} \cdot ( \begin{matrix}{x}_{n} ( t ) \\ {x}_{n - 1} ( t ) \\ ⋮ \\ {x}_{2} ( t ) \\ {x}_{1} ( t )\end{matrix} ) .$$

However, a direct calculation of the N-th power of the matrix T would be even more complex than carrying out N prior iterations of the shift register as is known from the prior art.

The matrix T^{N} will be determined in the following text by a fast and less complex method. This is based on the n×n matrix T*, which is the transposed matrix of the matrix T. The matrix T* is given by:

$${T}^{*} = ( \begin{matrix}0 & 0 & 0 & ⋯ & 1 \\ 1 & 0 & 0 & ⋯ & {c}_{n - 1} \\ 0 & 1 & 0 & & ⋮ \\ 0 & ⋯ & ⋰ & 0 & {c}_{2} \\ 0 & 0 & ⋯ & 1 & {c}_{1}\end{matrix} ) .$$

The invention is based on the observation that multiplication by the transposed matrix T* corresponds to the multiplication by the independent variable x in the remaining class ring of the polynomial ring modulo f*. The polynomial

f*(x)=1+cₙ₋₁·x+cₙ₋₂·x²+ . . . +c₁·x¹+xₙ

is in this case obtained by reflection of the coefficients of the polynomial

f(x)=1+c₁·x+c₂·x²+ . . . +cₙ₋₁·xₙ₋₁+xⁿ

This can also be written as:

f*(x)=xⁿ·f(x⁻¹).

The fact that multiplication by T* corresponds to multiplication by x modulo f* can be explained as follows:

Each remaining class modulo f* is a linear combination of the “cannonic base” [1], [x], . . . , [xⁿ⁻¹] modulo f*. It is thus sufficient to show that T* on this basis acts in the same way as multiplication by x modulo f*.

The equivalence class [1] modulo f* is given by the vector:

$$( \begin{matrix}1 \\ 0 \\ 0 \\ 0 \\ 0\end{matrix} ) .$$

Multiplication by T* results in the vector:

$$( \begin{matrix}0 \\ 1 \\ 0 \\ 0 \\ 0\end{matrix} ) ,$$

which corresponds to the equivalence class [x] modulo f*. This applies in the same way to all the equivalence classes [1], [x], . . . [xⁿ⁻²] modulo f*. The final equivalence class [xⁿ⁻¹] modulo f* corresponds to the vector:

$$( \begin{matrix}0 \\ 0 \\ 0 \\ 0 \\ 1\end{matrix} ) ,$$

which is mapped, during multiplication by T*, onto the vector

$$( \begin{matrix}1 \\ {c}_{n - 1} \\ ⋮ \\ {c}_{2} \\ {c}_{1}\end{matrix} ) ,$$

and this corresponds to the equivalence class [1+cₙ₋₁·x+cₙ₋₂·x²+ . . . +c₁·xⁿ⁻¹]mod f*. However, this equivalence class is precisely the same as the equivalence class [xⁿ] modulo f*, because

$$\begin{matrix}[ {x}^{n} ] mod {f}^{*} = [ {x}^{n} + {f}^{*} ] mod {f}^{*} \\ = [ {x}^{n} + 1 + {c}_{n - 1} \cdot x + {c}_{n - 2} \cdot {x}^{2} + … + {c}_{1} \cdot {x}^{n - 1} + {x}^{n} ] mod {f}^{*} \\ = [ 1 + {c}_{n - 1} \cdot x + {c}_{n - 2} \cdot {x}^{2} + … + {c}_{1} \cdot {x}^{n - 1} ] mod {f}^{*}\end{matrix}$$

In this case, “+” in each case means the addition in the corresponding body GF(2) with two elements, that is to say “+” corresponds to “XOR”.

Multiplication by T* for each base element is thus the same as multiplication by x modulo f*, and multiplication by T* is thus also the same as multiplication by T* for each polynomial.

Multiplication by (T*)^{N} is thus also the same as multiplication by x^{N} modulo f*.

This characteristic can be used to determine the matrix (T*)^{N}. The matrix (T*)^{N} describes a linear transformation which changes the polynomial [x^{j-1}]mod f* (where j=1, 2, . . . n) to the polynomial [x^{N+j-1}]mod f* multiplied by x^{N} modulo f*. In this case, the polynomial [x^{j-1}]mod f*, to be more precise the polynomial whose degree is less than n and which represents the remaining class [x^{j-1}]mod f*, is represented by the j-th unit vector. The polynomial [1]mod f* is thus represented by the first unit vector

$$( \begin{matrix}1 \\ 0 \\ ⋮ \\ 0\end{matrix} ) ,$$

and the polynomial [x]mod f* is represented by the second unit vector

$$( \begin{matrix}0 \\ 1 \\ ⋮ \\ 0\end{matrix} )$$

and so on. Multiplication of these unit vectors by the matrix (T*)^{N} changes the first unit vector to the column vector [x^{N}]mod f*, the second unit vector to the column vector [x^{N+1}]mod f*, and, in general, the j-th unit vector to the column vector [x^{N+j-1}]mod f*. The structure of the matrix (T*)^{N} is thus as follows:

$${( {T}^{*} )}^{N} = ( [ {x}^{N} ] mod {f}^{*} , [ {x}^{N + 1} ] mod {f}^{*} , ⋯ [ {x}^{N + n - 1} ] mod {f}^{*} ) .$$

This notation means that the j-th column in the matrix (T*)^{N} is formed by the coefficients of that representative of the remaining class [x^{N+-1}]mod f* which has the lowest degree. If this matrix is multiplied by the right by the j-th unit vector, then this results in the desired column vector [x^{N+j-1}]mod f*.

The operations of transposition and exponentiation may be interchanged for the matrix T. Thus,

(T*)^{N}=(T^{N})*.

The matrix T^{N} to be determined is thus:

$${T}^{N} = {( {t}_{j , k} )}_{j , k = 1 , 2 , … , n} = ( \begin{matrix}[ {x}^{N} ] mod {f}^{*} \\ [ {x}^{N + 1} ] mod {f}^{*} \\ ⋮ \\ [ {x}^{N + n - 1} ] mod {f}^{*}\end{matrix} ) .$$

The j-th row in the matrix T^{N} is formed by the coefficients of that representative from the remaining class [x^{N+j-1}]mod f* which has the lowest degree. This structure of the matrix T^{N} is illustrated in FIG. 2.

This completes the calculation of the matrix T^{N}.

The matrix T^{N} determined in this way can now be substituted in the iteration rule:

$$( \begin{matrix}{x}_{n} ( t + N ) \\ {x}_{n - 1} ( t + N ) \\ ⋮ \\ {x}_{2} ( t + N ) \\ {x}_{1} ( t + N )\end{matrix} ) = {T}^{N} \cdot ( \begin{matrix}{x}_{n} ( t ) \\ {x}_{n - 1} ( t ) \\ ⋮ \\ {x}_{2} ( t ) \\ {x}_{1} ( t )\end{matrix} )$$

The iteration rule for calculation of the state which has been iterated N times thus becomes:

$$( \begin{matrix}{x}_{n} ( t + N ) \\ {x}_{n - 1} ( t + N ) \\ ⋮ \\ {x}_{2} ( t + N ) \\ {x}_{1} ( t + N )\end{matrix} ) = ( \begin{matrix}[ {x}^{N} ] mod {f}^{*} \\ [ {x}^{N + 1} ] mod {f}^{*} \\ ⋮ \\ [ {x}^{N + n - 1} ] mod {f}^{*}\end{matrix} ) \cdot ( \begin{matrix}{x}_{n} ( t ) \\ {x}_{n - 1} ( t ) \\ ⋮ \\ {x}_{2} ( t ) \\ {x}_{1} ( t )\end{matrix} )$$

In order to calculate the matrix elements (t_{j,k})_{k=1, 2, . . . , n} for the j-th row in the matrix T^{N}, it is necessary to determine the coefficients of that polynomial which on the one hand belongs to the remaining class [x^{N+j-1}]mod f* and on the other hand has a degree less than n. This may be done by means of a so-called square and multiply algorithm. Algorithms such as these can use the remaining class polynomial g=[x]mod f*, which is used as an input variable for the algorithm, to determine the remaining class polynomial [x^{M}]mod f*, where M is an undefined natural number.

Let us assume that M=MᵣMᵣ₋₁Mᵣ₋₂ . . . M₁M₀ is a binary representation of the natural number M, with the most significant bit being Mᵣ=1. The corresponding square and multiply algorithm is then written as follows:

1. Set y←g

2. For i from r−1 down to 0 do

2.1 Set y←y2 mod f*

2.2 If Mᵢ=1 then set y←g·y mod f*

3. Output y

The square operation is carried out in line 2.1, and the multiply operation is carried out in line 2.2, provided that Mᵢ1=1. The operator “·” in this case denotes the multiplication of two remaining classes, and results in a representative of the resultant remaining class. Once the algorithm has been completed, the output y is the representative of the remaining class [x^{M}]mod f* with the lowest degree. The number of computation steps required, and hence also the computation time required, depend logarithmically on M.

The matrix elements of the matrix T^{N} are determined in accordance with a first embodiment of the invention by carrying out the square and multiply algorithm once for each row. The square and multiply algorithm for M=N+j−1 is thus called up in order to calculate the matrix elements for the j-th row, which is given by the coefficients of the remaining class polynomial [x^{N+j-1}]mod f*. All of the matrix elements can thus be determined by carrying out the square multiply algorithm n-times.

As an alternative to this, according to a second embodiment of the invention, only the matrix elements (t_{1,k})ₖ₌1, 2, . . . n in the first row of the matrix are determined by means of the square and multiply algorithm, while the matrix elements in rows 2 to n are obtained by iteration of the matrix elements in the first row. In this embodiment of the invention, the square and multiply algorithm can be called up only once. This embodiment of the invention therefore further reduces the computation complexity.

Thus, first of all, the square and multiply algorithm is called up for M=N N, in order to determine the first row (t_{1,1}, t_{1,2}, . . . t_{1,n-1}, t_{1,n}) in the matrix T^{N}. This row comprises the coefficients of the representative of the remaining class [x^{N}]mod f*, that is to say:

[x^{N}]modf*=[t_{1,1}+t_{1,2}·x+t_{1,3}·x²+ . . . +t_{1,n}·xⁿ⁻¹]mod f*

This first row of the matrix T^{N} should now be used as the basis for determining the following rows in the matrix iteratively. Two steps must be carried out in each case in order to determine the matrix elements in the subsequent, j-th row from the preceding (j−1)-th row. In a first step, the matrix elements in the (j−1)-th row are shifted by one position to the right, which corresponds to multiplication by x. Thus, for j=2, 3, . . . , n:

(t_{j,1},t_{j,2},t_{j,3}, . . . ,t_{j,n-1},t_{j,n}):=(0,t_{j-1,1},t_{j-1,2}, . . . ,t_{j-1,n-1}).

In this case, the last element in the (j−1)-th row, the matrix element t_{j-1,n}, is shifted out of the matrix. However, if the matrix element t_{j-1,n} is equal to 1, this matrix element t_{j-1,n} provides feedback and thus modifies the matrix elements in the j-th row. In the second step, it is therefore first of all necessary to check whether t_{j-1,n}=1. If t_{j-1,n}=1, an XOR addition of the reflected polynomial f*(x) and of the matrix elements (as obtained in the first step) in the j-th row t_{j,1}, t_{j,2}, . . . , t_{j,n-1}, t_{j,n}) is carried out. The reflected polynomial

f*(x)=1+cₙ₋₁·x+cₙ₋₂·x²+ . . . +xⁿ

can also be written as

f*(x)=f₁+f₂·x+f₃x²+ . . . +fₙ₊₁·xⁿ

and can thus be represented by the bit vector (f₁, f₂, . . . , fₙ₋₁, fₙ, fₙ₊₁). The following XOR addition must therefore be carried out in the situation where t_{j-1,n}=1:

t_{j,k}:=t_{j,k}⊕fₖ,

where k=1, 2, . . . , n denotes the various elements in the j-th row, and where the operator “⊕” represents the XOR addition.

All of the matrix elements in the matrix

T^{N}=(t_{j,k})_{_{j,k=1,2, . . . ,n}}

can be determined in this way.

The two steps of shifting to the right and XOR addition of f* in this case correspond precisely to the operations which a shift register of the MSRG type (Modular Shift Register Generator) would carry out for each clock pulse. The iterations which are required to determine the matrix elements are, however, carried out purely as calculations by means of a processor.

One of the most important applications of the invention is the production of spreading sequences for transmission systems which operate on the basis of a CDMA transmission method. These spreading sequences are pseudo-noise sequences which are produced either by a shift register arrangement of the SSRG type or else by a digital signal processor.

The invention makes it possible to calculate the content of the shift register arrangement which would result after carrying out N iterations. This initialization state, which has been shifted by N bits, can then be written to the register cells in the shift register arrangement. The shift register arrangement then uses this initialization state as the basis for production of a pseudo-noise sequence which is shifted by N bits and may be used as a spreading sequence.

The definitions of the codings which may be used for UMTS mobile radio are contained in “3GPP: Spreading and modulation (FDD)”, 3rd Generation Partnership Project TS 25.213, Release 1999. This defines, inter alia, the so-called scrambling codes by means of which the transmitted signals are coded. These scrambling codes are used, inter alia, to distinguish between signals which are transmitted from different base stations to one mobile station (downlink). In this case, different codes are used in the downlink mode, that is to say for transmission of a signal from the base station to the mobile station, than for transmission of a signal from the mobile radio user to the base station (uplink). Furthermore, the various logical channels are coded with different scrambling codes, for example for continuous data/speech transmission, for bundled transmission of data as packets and for matching between the transmitter and receiver. A selection may in each case be made from a family of codes in this case, with the codes within one family differing by their code numbers.

Essentially, three different types of scrambling codes exist in UMTS, and each comprise a sequence of complex numbers. The so-called long codes comprise 38400 numbers and have no repetitions within a time frame of 10 ms. In addition, there are so-called short codes, which are repeated every 256 characters, as well as so-called preamble codes, which comprise 4096. The long scrambling codes are the most complex and are defined in the UMTS standard by means of pseudo-noise sequences. In the downlink mode, that is to say when the signal is being transmitted from the base station to the mobile station, two different pseudo-noise sequences are used, with the associated irreducible polynomials being of degree 18 and being given by f(x)=1+x⁷+x¹⁸ and f(x)=1+x⁵+x⁷+x ¹⁰+x¹⁸.

For the situation where no offset is envisaged, the initial state, that is to say the initial register contents of the shift register arrangement, is stipulated explicitly by the 3rd Generation Partnership Project technical specification. The scrambling code with the number N is obtained from this code by taking account of an additional offset of N bits.

When using a square and a multiply method for calculation of remaining classes in polynomial rings, the method according to the invention can be implemented in order to determine a state which has been iterated N times solely by the use of shift operations. The method from the prior art, that is to say the processing of N prior iterations, can likewise be carried out by means of shift operations.

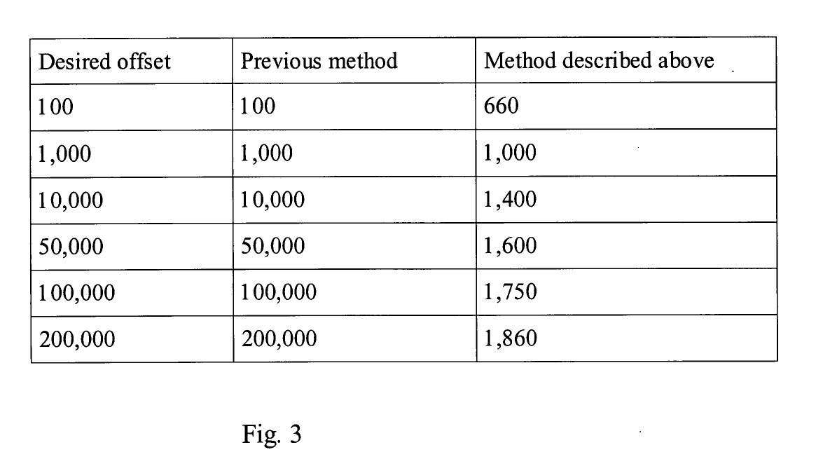

FIG. 3 shows a table indicating the number of operations required with the previous method (central column) and the number of operations required with the method according to the invention (right-hand column) for various values of the offset N. When implemented in practice, the number of operations required is approximately proportional to the time that is required. As can be seen, the previous method is fast enough only for very small values of the offset N. One major advantage of the new method is that the number of operations required depends logarithmically on the desired offset N. This leads to a significant reduction in the computation complexity and time required. Furthermore, the computation complexity and time required can be calculated considerably better in advance than in the case of the method according to the prior art. This is a critical advantage, particularly for mobile radio applications, which always have to take place in real time.

I claim:

1. A method for determination of a end state, which has n bits and is iterated N times, of a shift register arrangement from a given initial state, which has n bits, of the shift register arrangement, with the iteration rule for the shift register arrangement being given by the characteristic polynomial
f(x)=1+c₁·x+c₂·x²+ . . . +cₙ₋₁·xⁿ⁻¹+xⁿ
where c₁, c₂, . . . cₙ₋₁ε{0;1}, comprising the following steps:
a) determining the polynomial
f*(x)=1+cₙ₋₁·x+cₙ₋₂·x²+ . . . +xⁿ
by reflecting of the coefficients of the polynomial
f(x)=1+c₁·x+c₂·x²+ . . . +cₙ₋₁·xⁿ⁻¹+xⁿ;
b) for j=1, . . . n, determining that representative of the remaining class
[x^{N+-1}]modf*,
whose degree is less than n;
c) multiplying the bit sequence of the initial state by a matrix whose j-th row or j-th column for j=1, . . . , n is given by the coefficients of the representative of the remaining class
[x^{N+j-1}]modf*
as determined in step b).

2. The method as claimed in claim 1, wherein the representatives of the remaining classes
[x^{N}]modf*,[x^{N+1}]modf*, . . . [x^{N+n-1}]modf*
are each calculated explicitly by means of a suitable algorithm, in particular by means of a square and multiply algorithm.

3. The method as claimed in claim 1, wherein only the representative of the remaining class
[x^{N}]modf*
is calculated explicitly by means of a suitable algorithm, in particular by means of a square and multiply algorithm, and in that the representatives of the remaining classes
[x^{N+j-1}]modf*
where j=2, . . . , n are obtained by (n−1) calculated iterations from the coefficients of the representative of the remaining class
[x^{N}]modf*.

4. The method as claimed in claim 3, wherein the representatives of the remaining classes
[x^{N+j-1}] modf*
where j=2, . . . , n are obtained by (n−1) calculated iterations of a shift register arrangement of the MSRG type from the coefficients of the representative of the remaining class
[x^{N}]modf*
where the iteration rule for the shift register arrangement is given by the characteristic polynomial
f*(x)=1+cₙ₋₁·x+cₙ₋₂·x²+ . . . +xⁿ.

5. The method as claimed in claim 1, wherein the end state, which has n bits and is iterated N times, is used as an initialization state for the production of a pseudo-noise sequence which is shifted through N bits.

6. The method as claimed in claim 1, wherein the end state, which has n bits and is iterated N times, is written as the initialization state to a shift register arrangement which comprises n shift register cells.

7. The method as claimed in claim 6, wherein the shift register arrangement is a shift register arrangement of the SSRG type which comprises n shift register cells and whose structure is given by the characteristic polynomial
f(x)=1+c₁·x+c₂·x²+ . . . +cₙ₋₁·xⁿ⁻¹+xⁿ.

8. The method as claimed in claim 1, wherein the method is used in order to produce a spreading sequence with an offset of N bits in CDMA transmission systems, in particular CDMA transmission systems based on the UMTS or IS-95 transmission standards.

9. The method as claimed in claim 8, wherein the method is used for production of the scrambling codes which are defined in the UMTS standard.

10. The method as claimed in claim 8, wherein the spreading sequence is used for transmitter-end spread coding of the transmitted signals.

11. The method as claimed in claim 8, wherein the spreading sequence is used for receiver-end decoding of the received signals.

12. The method as claimed in claim 8, wherein the spread coding is started in the CDMA transmission system at a different time than the signal transmission, with the end state, which has n bits and is iterated N times, being used as the initialization state for the production of the time-shifted spreading sequence.

13. The method as claimed in claim 8, wherein a given code number defines the offset of a spreading sequence, with the end state, which has n bits and is iterated N times, being used as the initialization state for the production of the spreading sequence which is associated with the code number N.

14. An apparatus for determination of an end state, which has n bits and is iterated N times, of a shift register arrangement from a given initial state, which has n bits, of the shift register arrangement, with the iteration rule for the shift register arrangement being given by the characteristic polynomial
f(x)=1+c₁·x+c₂·x²+ . . . +cₙ₋₁·xⁿ⁻¹+xⁿ
where c₁, c₂, . . . cₙ₋₁ε{0;1}, comprising:
means for determination of the polynomial
f*(x)=1+cₙ₋₁·x+cₙ₋₂·x²+ . . . +xⁿ
by reflecting of the coefficients of the polynomial
f(x)=1+c₁·x+c₂·x²+ . . . +cₙ₋₁·xⁿ⁻¹+xⁿ;
means for remaining class determination and, for j=1, . . . , n, in each case determine that representative of the remaining class
[x^{N+j-1}] modf*
whose degree is less than n; and
means for multiplication of the bit sequence of the initial state by a matrix whose j-th row or j-th column for j=1, . . . , n is given by the coefficients of the representative of the remaining class
[x^{N+j-1}] modf*,
whose degree is less than n.

15. The apparatus as claimed in claim 14, wherein the means for remaining class determination in each case explicitly calculate the representatives of the remaining classes
[x^{N}]modf*,[x^{N+1}]modf*, . . . [x^{N+n-1}]modf*
by means of a suitable algorithm, in particular by means of a square and multiply algorithm.

16. The apparatus as claimed in claim 14, wherein the means for remaining class determination explicitly calculate only the representative of the remaining class
[x^{N}]modf*
by means of a suitable algorithm, in particular by means of a square and multiply algorithm, and in that the means for remaining class determination obtain the representatives of the remaining classes
[x^{N+j-1}]modf*
where j=2, . . . , n by (n−1) calculated iterations from the coefficients of the representative of the remaining class
[x^{N}]modf*.

17. The apparatus as claimed in claim 16, wherein the means for remaining class determination obtain the representatives of the remaining classes
[x^{N+j-1}]modf*
where j=2, . . . , n by (n−1) calculated iterations of a shift register arrangement of the MSRG type from the coefficients of the representative of the remaining class
[x^{N}]modf*
where the iteration rule for the shift register arrangement is given by the characteristic polynomial
f*(x)=1+cₙ₋₁·x+cₙ₋₂·x²+ . . . +xⁿ.

18. The apparatus as claimed in claim 14, wherein the apparatus for determination of an end state, which has n bits and is iterated N times, writes the end state as the initialization state in a shift register arrangement comprising n shift register cells.

19. The apparatus as claimed in claim 18, wherein the shift register arrangement is a shift register arrangement of the SSRG type which comprises n shift register cells (R₁, R₂, . . . , Rₙ) and whose structure is given by the characteristic polynomial
f(x)=1+c₁·x+c₂·x²+ . . . +cₙ₋₁·xⁿ⁻¹+xⁿ.

20. The use of an apparatus as claimed in claim 14 for production of a spreading sequence with an offset with N bits in a CDMA transmission system, in particular in a CDMA transmission system corresponding to one of the transmission standards UMTS or IS-95.

21. The use as claimed in claim 20, wherein the spreading sequence is used for transmitter-end spread coding of the signals to be transmitted.

22. The use as claimed in claim 20, wherein the spreading sequence is used for receiver-end decoding of the received signals.

23. The use as claimed in claim 20, wherein the spread coding is started in the CDMA transmission system at a different time than the signal transmission, with the end state, which has n bits and is iterated N times, being used as the initialization state for the production of the time-shifted spreading sequence.

24. The use as claimed in claim 20, wherein a given code number defines the offset of a spreading sequence, with the end state, which has n bits and is iterated N times, being used as the initialization state for the production of the spreading sequence which is associated with the code number N.
